(19) United States
(12) Patent Application Publication
(10) Pub. No.: US 2004/0015828 A1
(43) Pub. Date: Jan. 22, 2004

(54) Software architecture optimizing modularity

(76) Inventor: Sebastien MacKaie, Nice (FR)

Correspondence Address: PHILIPS INTELLECTUAL PROPERTY & STANDARDS, P.O. BOX 3001, BRIARCLIFF MANOR, NY, 10510, US

(21) Appl. No.: 10/099,687

(22) Filed: Mar. 15, 2002

(30) Foreign Application Priority Data
Mar. 20, 2001 (EP) 01400723.1

(51) Int. Cl. G06F 9/44

(52) U.S. Cl. 717/104; 717/107

(57) ABSTRACT

In a module-based software architecture, the impact of module replacement or removal is minimized by using an indirect calling technique. Where interactions between modules (M0-M4) are considered in terms of a client/server relationship, a server module (e.g. M3) is called by a client module (e.g. M1) using the server module's reference (&M3). The reference (&M3) of the module to be called (M3) is supplied as an input to the client module (M1). Each module is adapted to recognize as a null reference an input parameter taking a predetermined value. When the module to be called is identified by a null reference no call is made to that module.

The present invention relates to the design and reusability of software components and, more particularly, to a software architecture incorporating components susceptible to be reused. The present invention relates also to a method of producing a new module-based software architecture based on an existing one.

It has become common to generate new software not by writing a program from scratch but by altering, or reusing components of, existing programs. However, given that modules in a software architecture interact with each other, the removal or replacement of a module in an existing program can have very significant impact on the remainder of the architecture. More specifically, since modules that call another module (for example, a procedure) store the reference of the module to be called, changes in the program can make the stored references obsolete.

Various proposals have been made to simplify the re-use of existing software modules in new programs. Amongst these proposals, there has been a suggestion in U.S. Pat. No. 5,771,386 to adopt a module-based software architecture that is adapted to facilitate the re-use of the component modules.

In particular, U.S. Pat. No. 5,771,386 describes a software architecture made up of modules corresponding to compiled and individually-linked program units selected from a library of such program units. Each program unit has a header with a pre-defined structure including, at predetermined locations therein, address data relating to data or procedures of that program unit. A procedure that wishes to call data or a procedure in a given program unit need not know the address of the data or procedure in question, since it is programmed to know the location within the header of the program unit where it will find the address of the desired data or procedure. The described software architecture also incorporates a catalogue storing the memory locations of the headers of the various program units.

The software architecture of U.S. Pat. No. 5,771,386 makes it possible to re-use software modules with minimal changes thereto, and to assemble a program from such modules without needing to compile the assembled program. However, the component modules of this software architecture are compiled and individually-linked program units, and changes to software can often involve much more basic components of a program. Moreover, this known software architecture requires a predetermined header structure for the software modules, which imposes a certain degree of inflexibility on the design.

It is an object of the present invention to provide a software architecture enabling even low level components thereof to be modified (for example, removed or replaced) with reduced impact on the other components of the architecture.

It is a further object of the invention to provide a method of producing a new module-based software architecture based on an existing one, with a relatively low investment in time and cost to implement the changes.

In the present document, references to “components” of software or software “modules”, signify any software entity that can, directly or indirectly, receive input parameters and that can, directly or indirectly, provide output parameters and thus include, for example, functions/procedures, operating system tasks, or more general concepts, such as a layer.

The invention takes the following aspects into consideration. Interactions between modules in a software architecture can be considered in terms of a client/server relationship. A “server” module is called by a “client” module. A given module may both call other modules and itself be called by other modules and, thus, can be both a client and server. Instead of being pre-programmed with the references of the modules that it may call, each client module receives the reference(s) of its respective server modules as an input. In other words, a form of indirect calling is used. More generally, any module that requires the reference(s) of its server module(s) will get it (them) from its own client module(s).

The software architecture of the present invention enables modules to be interchanged or cancelled with relatively small modifications in the corresponding code, whilst maintaining the integrity of the modules. Thus, time and costs are saved during software development. This architecture can be adopted for any module-structured software.

In the software architecture according to the preferred embodiments of the present invention, replacement of a module in the architecture is straightforward—the reference of the new module, instead of the reference of the old (replaced) module, is simply passed as an input to the relevant client module(s). Thus, change is needed only at the level of an input to the system, rather than in each of the client modules calling the replaced server module.

In the software architecture according to the preferred embodiments of the present invention, removal of a module is achieved by replacing the reference to the old (removed) module by a null reference, that is, a constant reference taking a value which all modules are pre-programmed to recognize as not corresponding to any module in the architecture. The client modules receiving the null reference recognize that this null reference corresponds to a non-existent module and, thus, do not make a call thereto.

Since the modules of the software architecture according to the present invention no longer store references to potential server modules, the removal or replacement of such server modules has almost no impact on the potential caller modules.

The present invention provides a method of producing a new software architecture based on an existing module-based architecture.

The invention and additional features, which may be optionally used to implement the invention to advantage, are apparent from and elucidated with reference to the drawings described hereinafter.

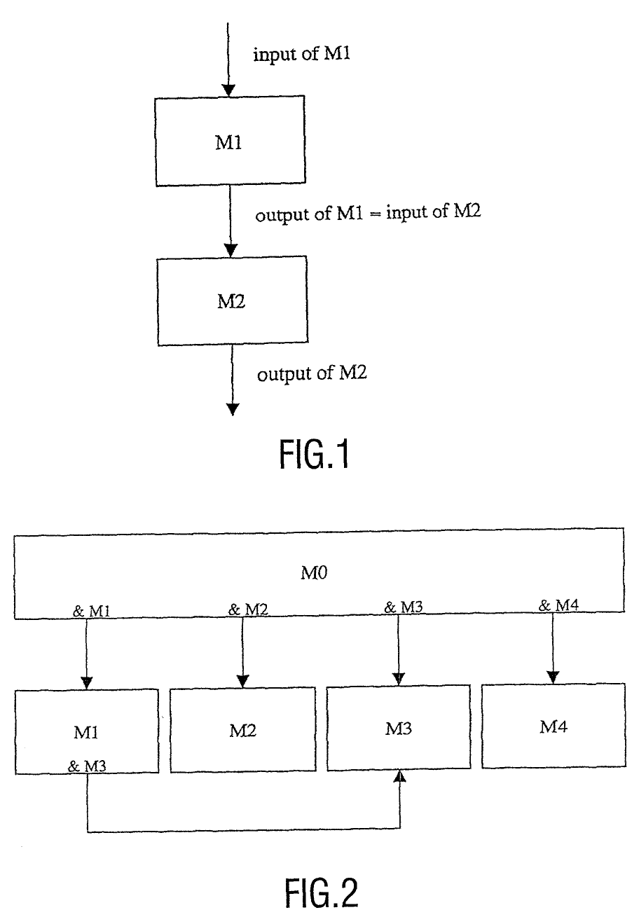

FIG. 1 is a schematic representation of two interacting modules in a software architecture;

FIG. 2 is a schematic representation of a conventional software architecture incorporating five interacting modules,

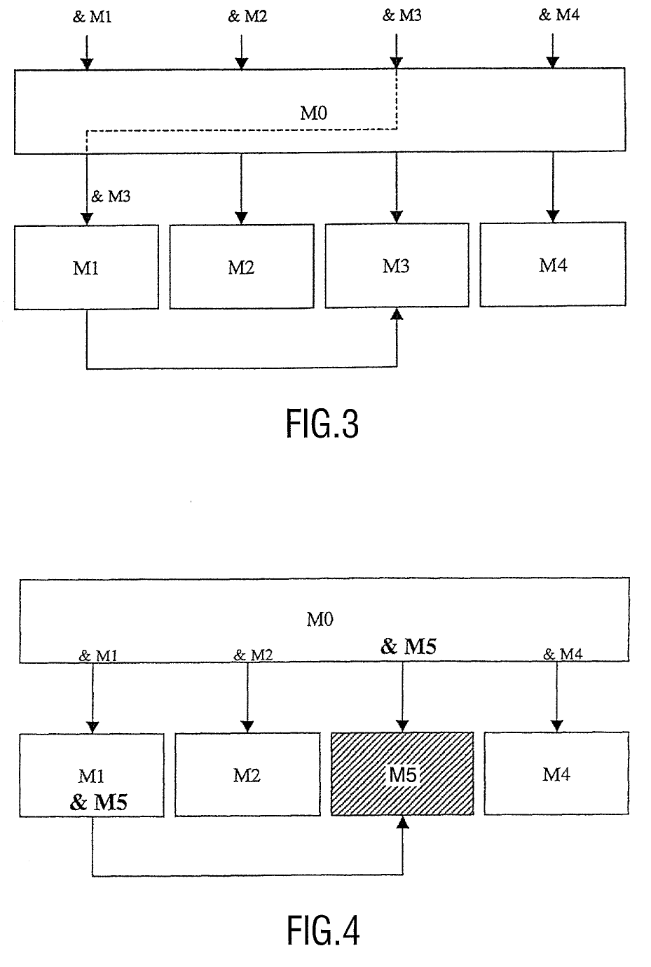

FIG. 3 is a schematic representation of a software architecture according to the present invention, incorporating five interacting modules;

FIG. 4 illustrates module replacement in the conventional software architecture of FIG. 2;

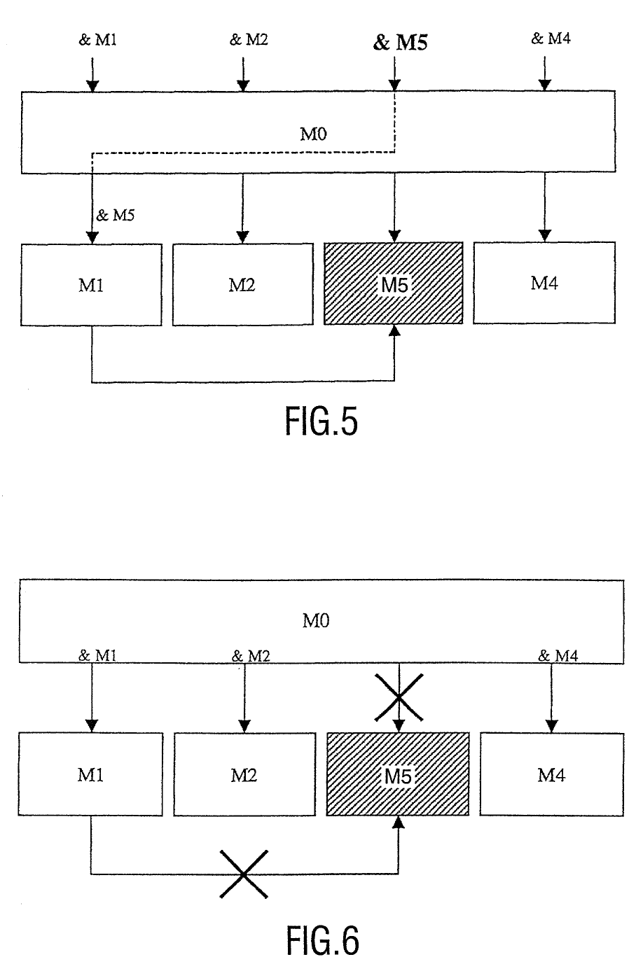

FIG. 5 illustrates module replacement in the software architecture of FIG. 3 according to the present invention;

FIG. 6 illustrates module removal in the conventional software architecture of FIG. 2;

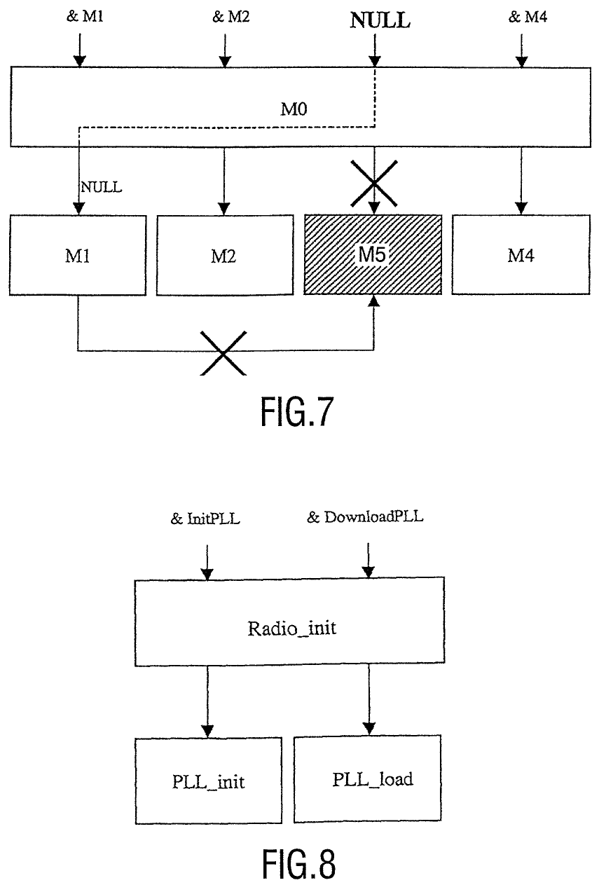

FIG. 7 illustrates module removal in the software architecture of FIG. 3 according to the present invention; and

FIG. 8 represents a radio driver in a mobile telephone, embodying a software architecture according to the present invention.

First some remarks will be made on the use of reference signs. Similar entities are denoted by an identical letter code throughout the drawings. Various similar entities may be shown in a single drawing. In that case, a numeral is added to the letter code so as to distinguish similar entities from each other. Notably, modules are designated “Mx”, where x is a number identifying each module, and the reference of a module is designated by use of the “&” symbol. Thus, the reference of module Mx is written “&Mx”. In the description and claims, any numeral in a reference sign may be omitted if appropriate.

The graphic conventions used in the present invention will be better understood from a consideration of FIG. 1, which illustrates two interacting modules M1 and M2. In this drawing (and all of the others), an arrow pointing to a module represents a call to this module, whereas an arrow exiting from a module represents a call made by this module to another one. The words labeling each arrow are inputs/outputs associated with the call in question. They represent the values of the inputs/outputs passed to the module when it is called. Thus, in the example illustrated in FIG. 1, a call is made to module M1 and that module receives as an input a parameter labeled “input of M1”. The module M1 makes a call to module M2, passing to M2 a parameter labeled “output of M1” and “input of M2”. The module M2 in its turn makes a call to a subsequent module (not shown), passing thereto a parameter labeled “output of M2”.

To aid understanding of the present invention, the following description compares an example of a conventional software architecture consisting of five interacting modules with a corresponding architecture implemented according to an embodiment of the present invention. It is to be understood that the present invention may be extended to much more complicated systems and, in general, is applicable to architectures incorporating any number of modules.

FIG. 2 represents the case of a conventional software architecture consisting of a module M0 which may call any one of four other modules, M1, M2, M3 and M4. The module M1 may itself call module M3. Module M0 stores the references, &M1, &M2, &M3 and &M4 of the four modules that it may call. Similarly, module M1 stores the reference &M3 of the module that it may call. During calls, no module reference parameters are passed between these modules.

FIG. 3 represents a software architecture according to the present invention consisting of the same modules M0 to M4, wherein M0 may call any one of four other modules, M1 to M4, and module M1 may itself call module M3. However, in this case there are no stored references. On the contrary, module M0 receives as input parameters the references &M1, &M2, &M3 and &M4 of the four modules that it may call. Similarly, module M1 receives from M0 the reference &M3 of the module that it may call. Furthermore, all the modules in this architecture are designed to recognize that a reference taking a certain constant value (NULL reference) corresponds to a non-existent module such that there is no need to make a call to this module.

More particularly, each module may be adapted to compare a received module reference with the NULL reference and, only if the result of the comparison is negative, to then make a call to the module corresponding to the received reference. The form that “a call” takes will depend upon the implementation—for example, it can consist in a jump to an address corresponding to the received module reference.

It will be understood that the modules may receive inputs (not shown in FIG. 3) that correspond to parameters other than module references. The inputs corresponding to module references are distinguished from other inputs by well-known means that will vary dependent upon the programming language used to implement the architecture. For example, the header or format of a message corresponding to a module reference may be different from the header or format of other inputs.

The significance of the differences between the software architectures of FIGS. 2 and 3 will be appreciated from the following description of the effect of replacing and removing a module from the original architecture.

FIGS. 4 and 5 illustrate the case where module M3 is replaced by a new module M5 in the conventional architecture of FIG. 2 and in the architecture of FIG. 3 according to the present invention, respectively.

It will be seen from FIG. 4 that, in the case of the conventional software architecture, replacement of module M3 by new module M5 necessitates modification of modules M0 and M1 so as to replace the obsolete reference &M3 with the new reference &M5. Thus, in this case replacement of a module requires changes to be made to two other modules.

By way of contrast, it will be seen from FIG. 5 that in the case of the architecture embodying the present invention, replacement of module M3 by new module M5 does not necessitate any change to modules M0 and M1. Only the reference passed as an input to module M0 changes (from &M3 to &M5). Module M0 will call new module M5 correctly because module M0 is already arranged to call the four modules whose references it receives as inputs. The call to M5 by module M1 will also automatically be made correctly because module M0 is already arranged to pass its third input parameter to module M1 and module M1 is already arranged to call the module whose reference it receives as an input from M0. By making use of the indirect calling technique of the present invention, only one input parameter of M0 has to be modified when module M3 is replaced by module M5. Modules M0 and M1 are unchanged.

FIGS. 6 and 7 illustrate the case where module M5 is removed from the conventional architecture of FIG. 4 and from the architecture of FIG. 5 according to the present invention, respectively.

It will be seen from FIG. 6 that, in the case of the conventional software architecture, removal of module M5 once again necessitates modification of modules M0 and M1. In this case, modules M0 and M1 have to be altered so as not to make calls to the removed module M5. Thus, in this case removal of a module requires changes to be made to two other modules.

By way of contrast, it will be seen from FIG. 7 that in the case of the architecture embodying the present invention, removal of module M5 does not necessitate any change to modules M0 and M1. Once again, only the reference passed as an input to module M0 changes (from &M5 to the NULL reference). Module M0 is already arranged to pass this NULL reference as an input to module M1 and modules M0 and M1 are already arranged to recognize that no call need be made to a module designated by the NULL reference. Thus the calls to removed module M5 are automatically cancelled.

The comparative example given above highlights the fact that the present invention enables changes to a module in a module-based software architecture to be accommodated with reduced impact on the remainder of the architecture.

In the software architectures according to the present invention, the first module in a chain of clients/servers (for example, M0 in the example of FIGS. 3, 5 and 7) derives from a memory, or from internal parameters, the module references that it needs for itself or for passing to other modules. In the case where these module references are provided from memory, minor reprogramming is necessary when a module “downstream” in the chain is replaced/removed. In the case where the module references are derived from internal parameters, then minor reprogramming of this first module will be needed when a “downstream” module is replaced/removed. However, the reprogramming required only concerns the initial source of the module reference of the replaced/removed module rather than the reprogramming, that would be required in the conventional case, of all potential client modules of the replaced/removed module.

FIG. 8 illustrates an example of the concrete application of the present invention in the field of mobile telephony, notably relating to a radio driver inside a mobile telephone. In the present example, the modules correspond to functions.

As illustrated in FIG. 8, the radio driver in a mobile telephone includes a function, here designated “Radio_init”, that initializes the radio. The Radio_init function calls two other functions one, here designated “PLL_init”, that initializes a phase locked loop (PLL) in the radio and another, here designated “PLL_load”, that programs the PLL. The functions PLL_init and PLL_load vary dependent upon the particular type of radio used within the mobile telephone. The function Radio_init is more general and, specifically, does not vary dependent upon the type of radio that is used. By adopting an architecture according to the present invention, wherein the Radio_init function does not store the references of the PLL_init and PLL_load functions, but receives those references as an input, different sets of PLL_init and PLL_load functions can be associated with a given Radio_init function, without any need to reprogram the Radio_init module. This saves time and costs during the development of radio driver software for mobile telephones using radios of different types.

The drawings and their description hereinbefore illustrate rather than limit the invention. It will be evident that there are numerous alternatives that fall within the scope of the appended claims.

Any reference sign in a claim should not be construed as limiting the claim.

1. A software architecture comprising a plurality of modules (M0-M4), at least one module of said plurality being a module (M1) adapted to call another (M3) of said plurality of modules using a reference (&M3) to said called module,
wherein the reference (&M3) of the module to be called is supplied as an input to said calling module (M1).

2. A software architecture as claimed in claim 1, wherein each of said plurality of modules (M0-M4) is adapted to recognize as a null reference an input parameter having a predetermined value and to not make a call when the module to be called is indicated by the null reference.

3. A software architecture according to claim 1, wherein each module (Mx) corresponds to a software entity selected in the group consisting of functions, procedures, operating system tasks, and layers.

4. A method of producing a new module-based software architecture based on an existing module-based architecture comprising a plurality of modules (M0-M4), at least one module of said plurality being a module (M1) adapted to call another (M3) of said plurality of modules using a reference (&M3) to said called module, wherein the reference (&M3) of the module to be called is supplied as an input to said calling module (M1), the method comprising the steps of:
removing at least one of said plurality of modules (M3), and
altering the value of inputs corresponding to the reference (&M3) of the removed module.

5. An architecture-producing method according to claim 4, wherein each of said plurality of modules (M0-M4) is adapted to recognize as a null reference an input parameter having a predetermined value and to not make a call when the module to be called is indicated by the null reference, and wherein the altering step comprises replacing inputs corresponding to the reference (&M3) of the removed module with a null reference.

6. An architecture-producing method according to claim 4, and comprising the step of replacing the removed module by a replacement module (M5) having a different reference (&M5), wherein the altering step comprises replacing inputs corresponding to the reference (&M3) of the removed module with inputs corresponding to the reference (&M5) of the replacement module.

7. An architecture-producing method according to claim 4, wherein each module (Mx) corresponds to a software entity selected in the group consisting of functions, procedures, operating system tasks, and layers.

8. A radio telephone including a phase locked loop intended to be controlled by means of a radio driver software having an architecture according to claim 1.
